(19) United States
(12) Patent Application Publication
(10) Pub. No.: US 2003/0188932 A1
(43) Pub. Date: Oct. 9, 2003

(54) Vehicle driveline temperature control including a thermoelectric device

(76) Inventors: Mark M. Schneider, Royal Oak, MI (US); Larry W. Bowman, Troy, MI (US); Eric B. Ratts, Northville, MI (US); Paul R. Sieber, Rochester Hills, MI (US); Robert W. Hildebrand, Rochester Hills, MI (US); Michael E. Johnson, Rochester, MI (US); James R. Brichta, Highland, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/117,578

(22) Filed: Apr. 5, 2002

(51) Int. Cl. F16D 55/02

(52) U.S. Cl. 188/71.6

(57) ABSTRACT

A temperature controlling assembly includes a thermoelectric device that is supported on or in a selected driveline component, such as an axle assembly or a brake assembly. The thermoelectric device preferably is controlled to operate in a first mode to remove heat from the selected component. In one example, fluid within a wet disc brake assembly is cooled using the thermoelectric device. In another mode of operation, the thermoelectric device provides heat to a selected lubricant. A controller monitors the temperature of the chosen component and causes the thermoelectric device to operate in the appropriate mode to maintain the component temperature within a desired range.

### BACKGROUND OF THE INVENTION

This invention generally relates to temperature control in vehicle driveline components. More particularly, this invention relates to utilizing a thermoelectric device to control the temperature of at least a portion of a driveline component on a vehicle.

A variety of vehicles are manufactured for a variety of purposes. Examples include passenger vehicles, heavy vehicles such as trucks, and off road vehicles. Each type of vehicle has particular component requirements to meet the needs of the typical situation in which the vehicle is placed during use. Accordingly, a variety of vehicle components have been developed, each having its own benefits and, in some cases, shortcomings or drawbacks.

In off-highway type vehicles, oil in the brake and axle assemblies tends to heat up during braking applications. In many cases, especially in the case of liquid cooled wet disc brakes, the generated heat exceeds that which can be dissipated by the axle assembly or brake assembly using normal passive methods.

The heat build up must be dissipated to maximize component life and performance. The fatigue performance of components such as gears decreases with incremental rises in temperature. By maintaining an adequate temperature for such components, the fatigue performance is enhanced.

Vehicle manufacturers and suppliers have been forced to design complex and often undesirably costly cooling systems in an attempt to regulate the temperature within the components resulting from braking applications. Alternative heat dissipation techniques are needed.

Another instance where temperature management is required is under cold conditions where oil (or another lubricant) becomes so thick that it is not capable of providing the needed lubrication for gear teeth contact surfaces, for example, until warming from frictional heat occurs. A temporary lack of lubrication under such circumstances often results in premature component wear or failure. It is, therefore, necessary to provide a robust, economical arrangement for warming a lubricant as may be needed.

This invention provides a temperature regulation strategy that economically maintains at least a portion of a driveline component, such as axle or brake assemblies, within a desired operating range.

### SUMMARY OF THE INVENTION

In general terms, this invention is a system for regulating a temperature of at least a portion of a vehicle driveline component. The inventive system is particularly well suited for regulating the temperature of oil, or another lubricant, within a brake assembly or an axle assembly.

A system designed according to this invention includes a thermoelectric device having a first side in thermal contact with at least a portion of the chosen vehicle driveline component. A second side of the thermoelectric device is in thermal communication with an outside of the component. A temperature sensor provides an indication of a temperature of the selected portion of the component. A controller provides a current to the thermoelectric device to cause heat transfer between the first and second sides of the thermoelectric device to adjust the temperature of the selected portion of the driveline component.

In one example, the thermoelectric device uses the Peltier effect to transfer heat between the first and second sides. The controller provides current to the thermoelectric device in a first mode to provide cooling to the selected portion of the driveline component. In the first mode, heat is transferred through the thermoelectric device from within the component to outside of the component. The controller provides current to the thermoelectric device in a second mode to provide heat to the selected portion of the vehicle component.

In one example, a plurality of heat transferring fins are coupled to the first and second sides to better conduct heat in the desired direction.

The various features and advantages of this invention will become apparent to those skilled in the art from the following detailed description of the currently preferred embodiments. The drawings that accompany the detailed description can be briefly described as follows.

### BRIEF DESCRIPTION OF THE DRAWINGS

FIG. 1 schematically illustrates a vehicle driveline system incorporating a temperature regulation assembly designed according to this invention.

FIG. 2 schematically illustrates selected portions of the embodiment of FIG. 1 in somewhat more detail.

FIG. 3 schematically shows the embodiment of FIG. 2 operating in a second mode.

FIG. 4 schematically illustrates an alternative arrangement of selected components of a thermoelectric device useful with an embodiment of this invention.

### DETAILED DESCRIPTION OF THE PREFERRED EMBODIMENTS

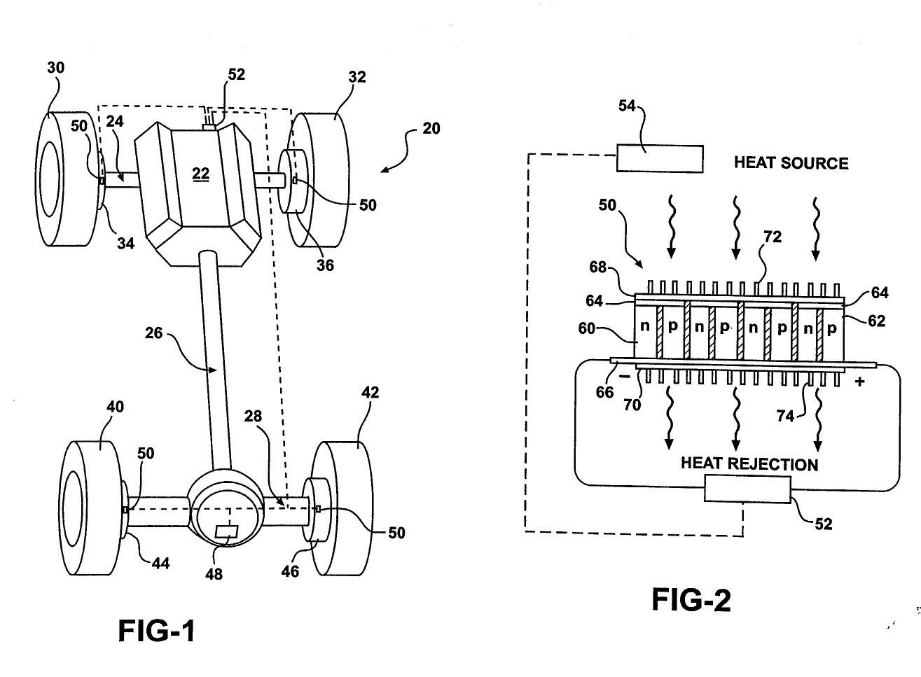

A vehicle driveline 20 is schematically illustrated in FIG. 1. An engine and transmission are schematically illustrated at 22. The engine and transmission 22 provides rotary forces to an axle assembly 24 and a drive shaft 26 to cause rotation of appropriate components of the axle assembly 24 and an axle assembly 28 as known in the art.

The axle assembly 24 facilitates appropriate rotation of wheels 30 and 32. Brake assemblies 34 and 36, respectively, provide a braking force as needed to slow down the rotation of the wheels 30 and 32.

The axle assembly 28 facilitates rotation of the wheels 40 and 42. Brake assemblies 44 and 46, respectively, provide braking forces as needed to slow down the rotation of the wheels 40 and 42.

The type of axle assemblies used or brake assemblies used will vary depending on the vehicle and the needs of a particular situation. In one example, the brake assemblies are wet disc brake assemblies.

A plurality of temperature control devices 48 and 50 are associated with selected portions of the axle assemblies and the brake assemblies. One axle assembly temperature regulation device 48 is illustrated, although more than one may be used on any particular axle assembly on a vehicle. Each of the brake assemblies 34, 36, 44 and 46 are shown with a temperature regulation device 50. It may be advantageous to include more than one temperature regulation device 50 on each brake assembly or to provide a temperature regulation device on only selected brake assemblies, depending on the needs of a particular situation. Those skilled in the art who have the benefit of this description will be able to determine how many temperature regulation devices will be needed to achieve a desired performance for a particular vehicle.

A controller 52 communicates with each of the temperature regulation devices 48, 50 and controls the operation of each of those devices. The temperature regulation devices preferably are thermoelectric devices that operate to transfer heat depending upon the mode of electrical current supplied to the device. The controller 52 preferably is programmed to supply electrical energy to the thermoelectric devices to regulate the temperature of the appropriate driveline component or components.

The thermoelectric devices preferably are the type that are capable of operating in two different modes. In one mode, the thermoelectric devices provide a heat dissipation or heat transfer function to remove heat from the vehicle components. In a second mode of operation, the thermoelectric devices provide a heat transfer function that effectively warms up or heats the components. The controller 52 preferably is programmed to supply the appropriate electric energy to the thermoelectric devices to achieve the desired operation. It is not necessary that the thermoelectric devices are capable of operating in two different modes. It is, however, preferred so that the greatest versatility in temperature regulation may be achieved.

In one example, the controller 52 is a dedicated, commercially available microprocessor that is programmed to achieve the results provided by this invention.

Given this description, those skilled in the art will be able to suitably program available microprocessors to achieve the desired results. In another example, the controller 52 is a portion of a controller already present on the vehicle. Engine controllers and other control modules are known and it is within the scope of this invention to utilize a portion of a known controller already on a vehicle and to suitably program it to operate consistent with the controller 52 of this description.

Referring to FIG. 2, the thermoelectric device 50 is associated with a temperature sensor 54 that is strategically placed relative to the vehicle component so that the temperature of the portion of the component of interest can be monitored. A variety of temperature sensors are known and those skilled in the art who have the benefit of this description will be able to select an appropriate sensor to function within the environment of a selected component. The temperature sensor 54 preferably communicates with the controller 52 to provide an indication of the temperature of the selected portion of the selected component. In one example, the temperature sensor 54 is positioned to be within the lubricant of a wet disc brake assembly.

Depending on the determined temperature, the controller 52 provides current to the thermoelectric device 50 to adjust the temperature as may be needed.

The illustrated example includes a thermoelectric device 50 that uses the known Peltier effect for transferring heat. A plurality of n-type semiconductor elements 60 are electrically coupled with a plurality of p-type semiconductor elements 62. A plurality of electrical conductors 64, which can be made from copper for example, couple each n-type semiconductor element with a corresponding p-type semiconductor element 62 on a first side of the device 50. Another plurality of conductor portions 66 couple the n-type elements 60 and p-type 62 semiconductor elements on a second side of the device. An electrical insulator 68, which may be made from a ceramic material for example, is associated with the conductors 64 on the first side of the device 50. Another insulating layer 70, which may also be made from a ceramic material, is associated with the conductor 66 on the second side of the device 50

FIG. 2 illustrates the device 50 operating in a first mode where the controller 52 provides current to the conductors 66 in a first mode. The direction of current flows is indicated by the polarity signs near the conductors 66 at the right and left ends of the device schematically shown at 50. In this mode, the first side of the device 50 operates as a heat absorbing side to draw heat from the vehicle component. The device 50 preferably is supported by the component assembly (i.e., the brake assembly housing) so that a plurality of heat conducting fins 72, which are thermally coupled with the insulating layer 68, contact the desired portion of the component, such as oil within the assembly. The device 50 operates to absorb heat from the oil (or other portion of the component assembly) and transfers it through the device 50 where it is rejected outside of the driveline component through fins 74 that are thermally coupled with the insulating layer 70.

The thermoelectric device 50 takes advantage of the known Peltier effect to transfer heat built up within the oil in the selected portion of the component and to transfer it outside of the component assembly. The fins 74 preferably are situated to be in thermal communication with an outside of the component housing.

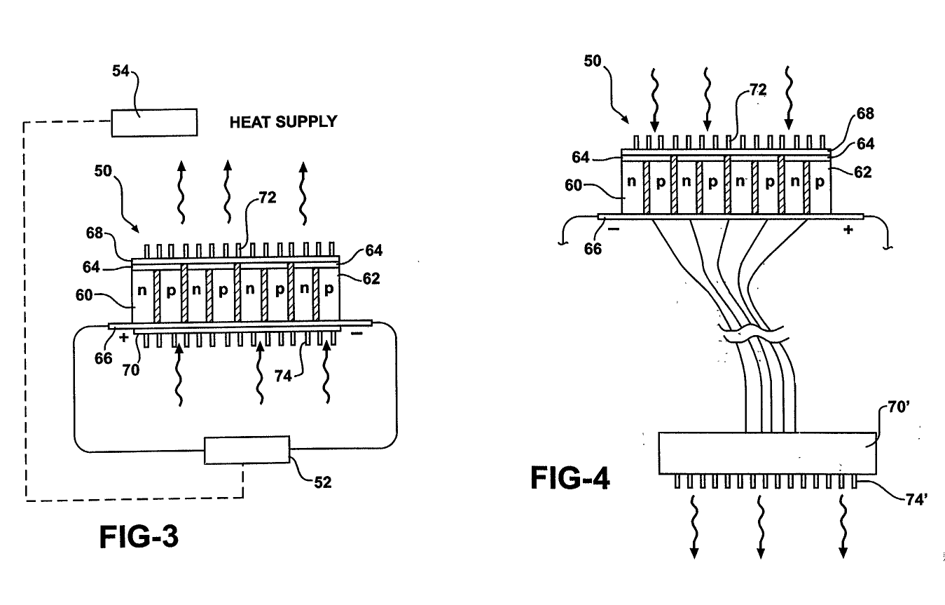

FIG. 3 illustrates the device 50 operating in a second mode. In this example, the controller 52 provides current to the conductors 66 in an opposite direction compared to FIG. 2. This is indicated by the changed polarity signs in FIG. 3 compared to FIG. 2. In this mode, the fins 74 and the insulating layer 70 act as a heat absorbing side. Heat is then transferred through the device 50 and emanates from the fins 72 to supply heat into the chosen component. This mode of operation is useful in locations, such as northern portions of North America where temperatures may be low for long periods of time. In this way, the inventive arrangement provides an economical heat source to warm up lubricants to enhance component performance and to prolong component service life.

The controller 52 preferably is programmed to monitor the temperature gathered by the temperature sensor 54. Whenever that temperature is outside of a selected range (i.e., too high or too low), the controller 52 preferably energizes the thermoelectric device 50 to cause heat transfer in a desired direction to adjust the temperature of the selected portion of the selected component.

Depending on the selection of materials used to make the thermoelectric device 50, the distance between the first and second sides of the device may be adjusted. As known, when materials such as CoSi, Ge—Te, In—As, Pb—Te, Mn—Te or Bi—Te are used, the distance between the two sides (i.e., the hot and cold junctions) of the thermoelectric device 50 must be relatively small. If a material such as Chromyl-Constantan is used, the distance between the hot and cold junctions of the thermoelectric device 50 may be relatively long. This is shown in the example of FIG. 4, where the layer 70′ and the conducting fins 74′ are remotely located relative to the remainder of the device 50, which is supported on or in the selected component.

A bundle of conductors 80 transfer electrical energy between the conductor 66 and the layer 70′. These conductors preferably do not transfer heat, but electrical energy which is then converted into heat at the layer 70′ and the fins 74′. Such an arrangement provides the ability to advantageously locate the fins 74′ to achieve maximum air flow for more effective or more rapid cooling. In one example, the fins 74 and the insulating layer 70 are positioned near the front of the vehicle where maximum air flow is available because of expected vehicle movement. In another example, the layer 70′ and fins 74′ are supported relative to the roof of the vehicle. A variety of strategic locations may be implemented to achieve the maximum desired heat transfer effect.

Depending on the particular vehicle and the expected use of the vehicle, the inventive system is readily customizable. Where less heat transfer is desired, only selected ones of the conducing junctions 62 and 64 may be chosen to be activated. In one example a manual selection is made during installation where a desired number of the conductors are set to receive current. In another example the controller 52 effectively switches on only selected portions of the thermoelectric device responsive to programming.

This invention provides a robust, economical technique for transferring heat out of or into a selected portion of a driveline component, such as the fluid within a wet disc brake assembly.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A system for controlling a temperature within a vehicle driveline component, comprising;
a thermoelectric device having a first side in thermal contact with at least a portion of the component and a second side in thermal communication with an outside of the component;
a temperature sensor that provides an indication of a temperature of at least a portion of the component; and
a controller that communicates with the sensor and provides a current to the thermoelectric device to cause heat transfer between the first and second sides of the device to selectively adjust the temperature of the portion of the component.

2. The system of claim 1, wherein the thermoelectric device utilizes the Peltier effect to transfer heat between the first and second sides.

3. The system of claim 2, wherein the controller provides a first current to the thermoelectric device when at least the portion of the component should be cooled and provides a second current to the thermoelectric device when at least the portion of the component should be heated.

4. The device of claim 1, including a plurality of heat transferring fins coupled to the second side and wherein the fins are positioned to contact airflow.

5. The device of claim 4, wherein the fins are located remotely from the component and including a plurality of conductors that carry electrical energy between the portion of the thermoelectric device in contact with the component and the remotely located fins.

6. The system of claim 1, wherein the portion of the component comprises a lubricant located within a housing of the component.

7. The system of claim 1, wherein the portion of the component comprises a housing of the component.

8. The system of claim 1, wherein the component comprises a wheel brake assembly.

9. The system of claim 1, wherein the component comprises an axle assembly.

10. The system of claim 1, including a plurality of junctions coupling the first side to the second side and wherein only selected ones of the junctions are activated to achieve a chosen heat transfer capacity.

11. A vehicle driveline, comprising:
at least one axle assembly supporting at least one wheel, having a housing and containing a lubricant;
at least one brake assembly associated with the wheel adapted to provide a braking force to stop the wheel from rotating;
a thermoelectric device associated with at least one of the brake assembly or the axle assembly, the thermoelectric device having a first side in thermal contact with at least the brake or axle assembly and a second side in communication with an outside of the corresponding assembly; and
a controller that provides a current to the thermoelectric device to cause heat transfer between the first and second sides of the device to adjust the temperature of at least a portion of the corresponding assembly.

12. The driveline of claim 11, including a sensor that provides an indication of a temperature of the portion of the corresponding assembly to the controller.

13. The driveline of claim 11, wherein the thermoelectric device utilizes the Peltier effect to transfer heat between the first and second sides.

14. The driveline of claim 11, wherein the controller provides current to the thermoelectric device in a first mode when the portion of the corresponding assembly should be cooled and provides current to the thermoelectric device in a second mode when the portion of the corresponding assembly should be heated.

15. The driveline of claim 11, including a plurality of heat transferring fins coupled to the second side and wherein the fins are positioned to contact airflow.

16. The driveline of claim 15, wherein the fins are located remotely from the component and including a plurality of conductors that carry electrical energy between the portion of the thermoelectric device in contact with the component and the remotely located fins.

17. The driveline of claim 11, including a plurality of thermoelectric devices, at least one associated with the axle assembly and at least one associated with the brake assembly.
